(19) United States
(12) Patent Application Publication
(10) Pub. No.: US 2011/0106696 A1
(43) Pub. Date: May 5, 2011

(54) Systems, Methods and Computer Program Products for Payment Processing

(76) Inventor: Ryan Seven, Costa Mesa, CA (US)

(21) Appl. No.: 12/917,204

(22) Filed: Nov. 1, 2010

Related U.S. Application Data
(60) Provisional application No. 61/256,896, filed on Oct. 30, 2009.

(51) Int. Cl. G06Q 40/00

(52) U.S. Cl. 705/40

(57) ABSTRACT

Systems, methods and computer program products are provided for payment processing and employee compensation disbursement. Employee compensation is determined and disbursed into virtual accounts associated with corresponding employees, so as to avoid costs associated with traditional check distribution. Employees are provided with a means for accessing funds stored in their virtual accounts and utilizing such funds in a variety of possible manners, where employers are provided with the benefit of the float on the employee compensation funds until the funds are actually retrieved by the employees from their virtual accounts. Incentives are also provided for employees to use funds in their virtual accounts to purchase products, merchandise and/or services back from the employer company, so that the company employer further benefits from increased sales and the ability to retain funds allocated to virtual accounts.

### CROSS REFERENCE TO RELATED APPLICATION(S)

This application claims priority to U.S. Provisional Patent Application Ser. No. 61/256,896, entitled “Novel Systems, Methods and Machine-Readable Mediums for Payment Processing,” filed on Oct. 30, 2009, the contents which are incorporated herein by reference in its entirety.

### BACKGROUND OF THE INVENTION

1. Field of the Invention

The invention relates generally to the processing of payments and, more particularly, to systems, methods and computer program products for the processing payments and the disbursement of employee compensation.

2. Background Discussion

Currently, company employees, agents and/or independent contractors (collectively referred to herein as “employees”) are typically paid by checks issued to the employees. However, there are numerous disadvantages associated with the use of checks to pay employees. Checks are costly to issue in view of (i) the materials costs associated with the printing of physical checks, (ii) the costs associated with mailing or otherwise distributing checks, (iii) and the manpower associated with signing and distributing the checks. Checks can also get lost or stolen, thereby requiring time, effort and costs associated with replacing lost checks. There are also escheatment issues associated with issued checks.

There have been some attempts at using prepaid debit cards as a method of compensation. However, there are also disadvantages associated with the use of prepaid debit cards. For example, a company compensating employees using prepaid debit cards lose the float on the money paid to the employees since the money is immediately withdrawn from the company's bank account upon funding of the prepaid debit card. Since companies do not get paid interest on money once it is transferred on to a prepaid debit card, there is financial disincentive for companies to lose this float period and have employee payments immediately transferred to prepaid debit cards. It is also not uncommon for a certain percentage of checks that are issued to employees to never be cashed, where employers will typically gain the windfall of these uncashed checks (known in the industry as “breakage”). However, with prepaid debit cards in which payment is immediately made, employers never get the advantage of there being unrealized funds paid to employees. There are also financial costs associated with the use of prepaid debit cards, as employees often are required to pay a monthly fee just to maintain the prepaid debit card and, like checks, there is a cost to the employers associated with issuing the prepaid debit cards.

### SUMMARY

Systems, methods and computer program products are provided for payment processing and compensation disbursement of employees and independent contractors. In accordance with one or more embodiments, employee compensation determinations are received and funds associated with such compensation determinations are disbursed into virtual accounts associated with respective employees. Employees are also provided with a means for accessing funds stored in their virtual accounts and utilizing such funds in a variety of possible manners. In one or more embodiments, employees are provided with a value-bearing instrument in order to access and utilize such funds.

In one or more embodiments, for each employee virtual account, the employee may select to (i) maintain the dispersed funds within the virtual account, (ii) transfer funds from the virtual account to another account associated with the employee or otherwise receive payment based on such funds, or (iii) purchase products and/or services from their employer or another entity. In order to incentivize the employee to use the funds in their virtual account to purchase products and/or services, a company (e.g., the employer) may provide a discounted price for the employee to purchase such products and/or services in this manner or provide the employee with an increased commission paid on purchases performed from their virtual account in this manner.

In one or more embodiments, by disbursing employee compensation funds into virtual accounts associated with the employees, these employee compensation funds may be maintained in a company trust account until actually transferred by the employees into their own bank accounts or otherwise used in exchange for products/services. This provides the employer with the benefit of accruing interest on interim time between when funds are made available in the employees' virtual accounts and when the funds are used by the employees (i.e., the float time) and also allows the employer to retain an advantage of retaining or using any unrealized funds that remain in the employees' virtual accounts.

### DRAWINGS

The features and objects of the present disclosure will become more apparent with reference to the following description taken in conjunction with the accompanying drawings and in which:

FIG. 1 is a block schematic illustration of a system for payment processing and employee compensation disbursement in accordance with one or more embodiments of the present disclosure.

FIG. 2 is a block schematic illustration of another system for payment processing and employee compensation disbursement in accordance with one or more embodiments of the present disclosure.

FIG. 3 is a block schematic illustration of yet another system for payment processing and employee compensation disbursement in accordance with one or more embodiments of the present disclosure.

### DETAILED DESCRIPTION

In the description that follows, the present inventions may be described in reference to one or more embodiments that facilitates payment processing. The present inventions, however, are not limited to any particular application nor is it limited by the examples described below. Various modifications to the disclosed embodiments may be apparent to those skilled in the art and the general principles defined herein may be applied to other embodiments and applications without departing from the spirit and scope of the inventions. Therefore, the description of the embodiments that follow are for purposes of illustration and not limitation.

Reference in this specification to “one embodiment”, “an embodiment”, “other embodiments”, or the like means that a particular feature, structure, or characteristic described in connection with the embodiment is included in at least one embodiment of the disclosure. The appearances of, for example, the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

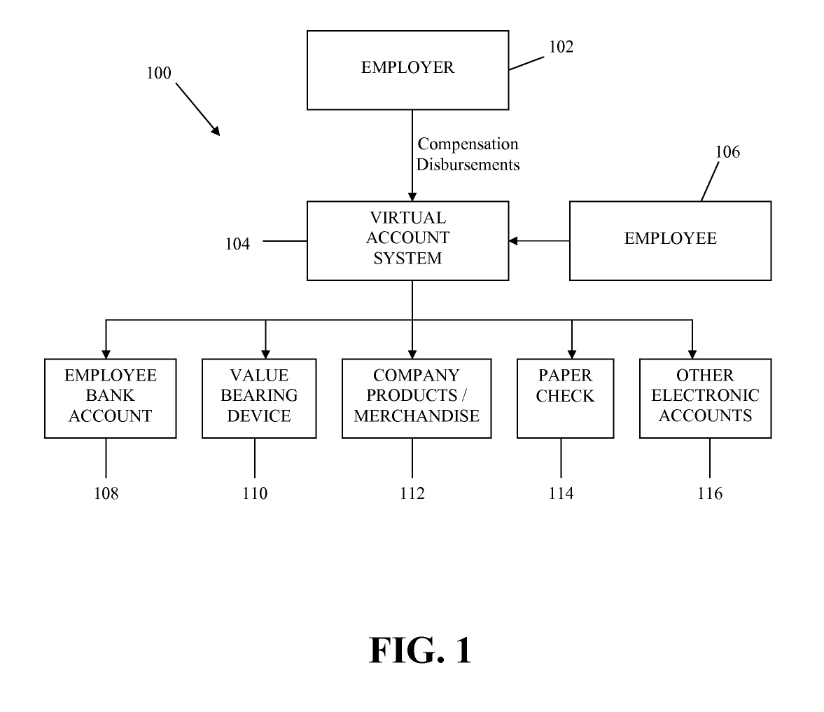

In accordance with one or more embodiments, systems, methods and computer program products are provided for payment processing and compensation disbursement of employees. As described herein, “employees” may refer to company employees (e.g., W2 employees), agents (e.g., 1099 agents), independent contractors, and/or independent business owners or distributors or any individual receiving compensation for work performed for an employer. Referring now to FIG. 1, a block schematic illustration of a system 100 for payment processing and employee compensation disbursement in accordance with one or more embodiments of the present disclosure is provided.

The system 100 includes an employer 102 that requires employee compensation disbursements to be delivered to an employee 106, where such compensation may be the form of monetary compensation, credits, rewards or units that have some corresponding monetary value. The employer 102 determines what compensation is to be disbursed to its employees and delivers the compensation disbursements to a virtual account system 104. The virtual account system 104 utilizes the compensation disbursement information received from the employer 102 to place corresponding value into virtual accounts associated employees to be paid.

Employees 106 may then access their virtual account contained within the virtual account system 104 and select the manner in which the funds available in the employee's virtual account are to be handled. In one or more embodiments, the employees are able to select from one or more of the following available options for handling the funds contained in their virtual account: (i) maintain the dispersed funds within the virtual account; (ii) transfer funds from the employee's virtual account to the employee's bank account 108; (iii) transfer funds from the employee's virtual account to a value bearing device 110 or instrument, such as a payroll debit card, FOB, a branded debit/credit card (e.g., Visa® or Mastercard®), an account stored on another device such as a mobile phone, etc.; (iv) use funds available from the employee's virtual account to purchase products, merchandise and/or services 112 from the employer 102 or another source; (v) issue a paper check 114 (although the costs associated with paper checks are intended to be avoided by various embodiments described herein and such costs can be charged to the employee 106 if such option is selected by the employee 106); or (v) transfer funds from the employee's virtual account to another virtual account 116 or other type of electronic funds transfer to another account.

In accordance with one or more embodiments, the use of the virtual accounts described to compensate employees herein provides employers 102 with all of the positive benefits associated with issuing conventional paper checks or prepaid payment cards without suffering the disadvantages associated with such conventional practices. For example, the use of virtual accounts eliminates the costs associated with issuing checks and further eliminates the fees to employers 102 and employees 106 associated with prepaid payment cards. Further, employers 102 can retain a float on the money to be paid to employees 106 while these funds sit in the virtual accounts of the employee 106. Employers 102 also retain the advantage of using funds made available to employees 106 in their virtual accounts but which are never used (e.g., similar to breakage when checks are never cashed by employees but with the added benefit of never incurring the costs associated with distributing the checks). Additional advantages for employers 102 include reducing processing fees as much as 50% or more when employees 106 purchase product back from the employers 102 from their virtual accounts, since employers 102 will be charged less processing fees for purchases made from the virtual accounts than the credit card processing fees typically incurred from an original purchase. Additional advantages for employers 102 also include the ability to eliminate charge backs and the need for a reserve account. Employers 102 could also implement, at no additional cost, a turnkey loyalty program (e.g., rewards program) for the company's employees and customers who use funds available from the employee's virtual account to purchase products, merchandise and/or services 112 from the employer 102 or another source.

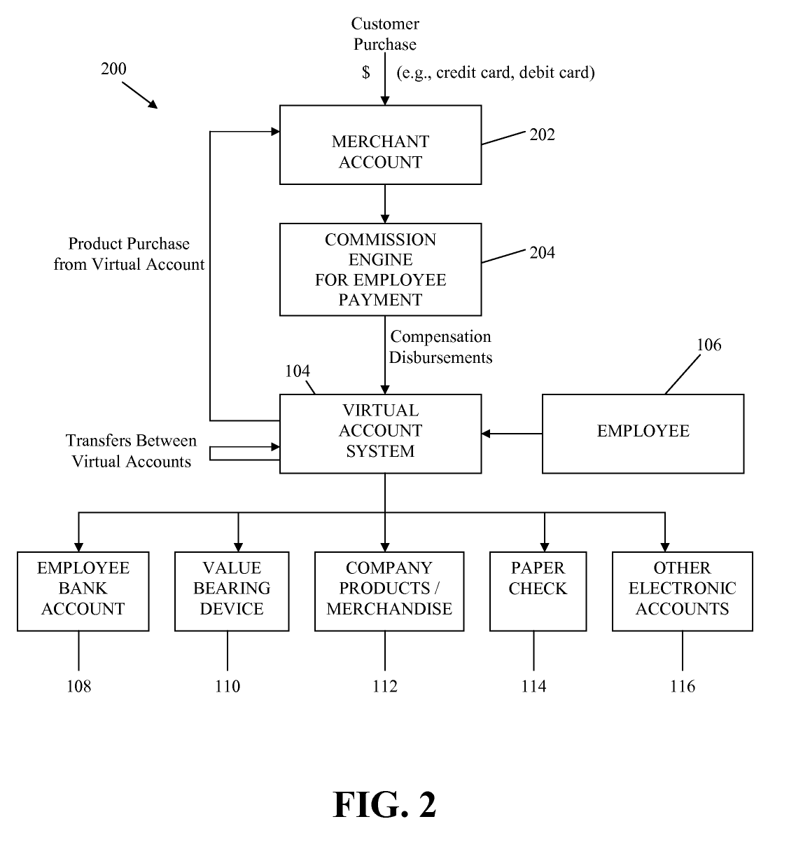

Referring now to FIG. 2, a block schematic illustration of another system 200 for payment processing and employee compensation disbursement in accordance with one or more embodiments of the present disclosure is provided. The system 200 of FIG. 2 is similar to that of the system 100 of FIG. 1 having been further modified to illustrate the effectiveness of the system 200 in handling payment processing for employees receiving commission payments (e.g., multi-level marketing companies).

In one or more embodiments, the system 200 includes a merchant account 202 that handles the processing of electronic payment transactions (e.g., credit card, debit card, electronic fund transfer, etc.) associated with customer purchases. A commission engine 204 operated by the employer 102 then determines the appropriate commissions or compensation to be paid to the employee (e.g., distributor for a multi-level marketing company), where again the commissions may be the form of monetary compensation, credits, rewards or units that have some corresponding payment value. The compensation disbursements are delivered to the virtual account system 104, which operates similarly as described above in connection with FIG. 1 for allowing the employee 106 to select the manner in which the funds available in the employee's virtual account are to be handled.

In one or more embodiments, the system 200 further provides employees 106 with the ability to purchase products, merchandise and/or services back from the employer 102 associated with merchant account 202. This methodology is particularly advantageous to the employer 102, since the actual funds that are available for use in the employees' virtual accounts are still in the possession of the employer 102 (e.g., in a company trust account) and the employer 102 is able to always maintain such funds associated with the subsequent purchases back from the employer 102. The employer 102 may provide incentives to the employees 106 to purchase products, merchandise and/or services from their virtual accounts in this manner, as this significantly reduces overhead and other transactional costs for the employer 102 and this also promotes the purchase of additional products, merchandise and/or services. For example, the merchant account 202 handling the processing of electronic payment transactions associated with original customer purchases may be charged traditional credit card or debit card convenience charges (e.g., 3-5% of purchase). In contrast, the employer 102 may only be charged a fraction of this amount (e.g., 1%) in convenience charges for purchases back from virtual accounts, where the employer 102 may choose pass along some of its savings to the employees 106 that choose to purchase products back from the employer 102 through their virtual accounts instead of purchasing them through the front end using traditional credit card or debit card methodologies. The savings may be passed along to the employees 106 in the form of discounts, rewards or other incentives.

In one or more embodiments, the system 200 may employ a rewards based system where the compensation disbursements in the employees' 106 virtual accounts are the form of units that have a corresponding monetary value. When employees 106 purchase products, merchandise and/or services back from the employer 102 from their virtual accounts, the employees 106 may be provided additional rewards points. For example, an employee 106 may receive compensation for certain customer purchases that occur through the merchant account 202, such as receiving 1 unit of rewards points for each dollar of purchased value (e.g., a multi-level marketing distributor may receive commissions based on customer purchases and receive such rewards points as a commission based on the value of such purchases), where such units of rewards points will be stored in the employee's 106 virtual account. For purchases back from the employer 106 using funds made available in the employee's 106 virtual account, this same employee 106 (e.g., multi-level marketing distributor) may then receive an increased level of rewards points for each dollar of purchased value based on purchases from the virtual account (e.g., 1.5 units of rewards points for each dollar of purchased value from virtual account funds). This would incentivize the employee 106 to purchase additional products, merchandise and/or services back from the employer 102 from their virtual accounts as opposed to making similar purchases through the front end using traditional credit card or debit card methodologies.

In one or more embodiments, employees 106 may further be provided with the opportunity to transfer funds from other sources into their virtual account so that the employees 106 can take advantage of the benefits offered by the employer 102 in making purchases back from the employer 102 through virtual account funds. For example, employees 106 may transfer funds into their virtual accounts from their bank account 108 through electronic funds transfer, from a value bearing device 110 or instrument, from payment via a paper check 114, or from transfer via another virtual account 116 or other type of employee account. One manner for an individual to transfer funds into an electronic funds account is described in U.S. Letters Pat. No. 7,177,830, the contents of which are hereby incorporated by reference herein in its entirety.

In one or more embodiments, employees 106 may further be provided with the opportunity to transfer funds from their virtual account into the virtual accounts of other employees 106. For example, in the case of a multi-level marketing distributor who received compensation placed into his/her virtual account, the distributor may decide to transfer some of their compensation into the virtual account belonging to another distributor in their multi-level hierarchy as a further reward for their sales efforts.

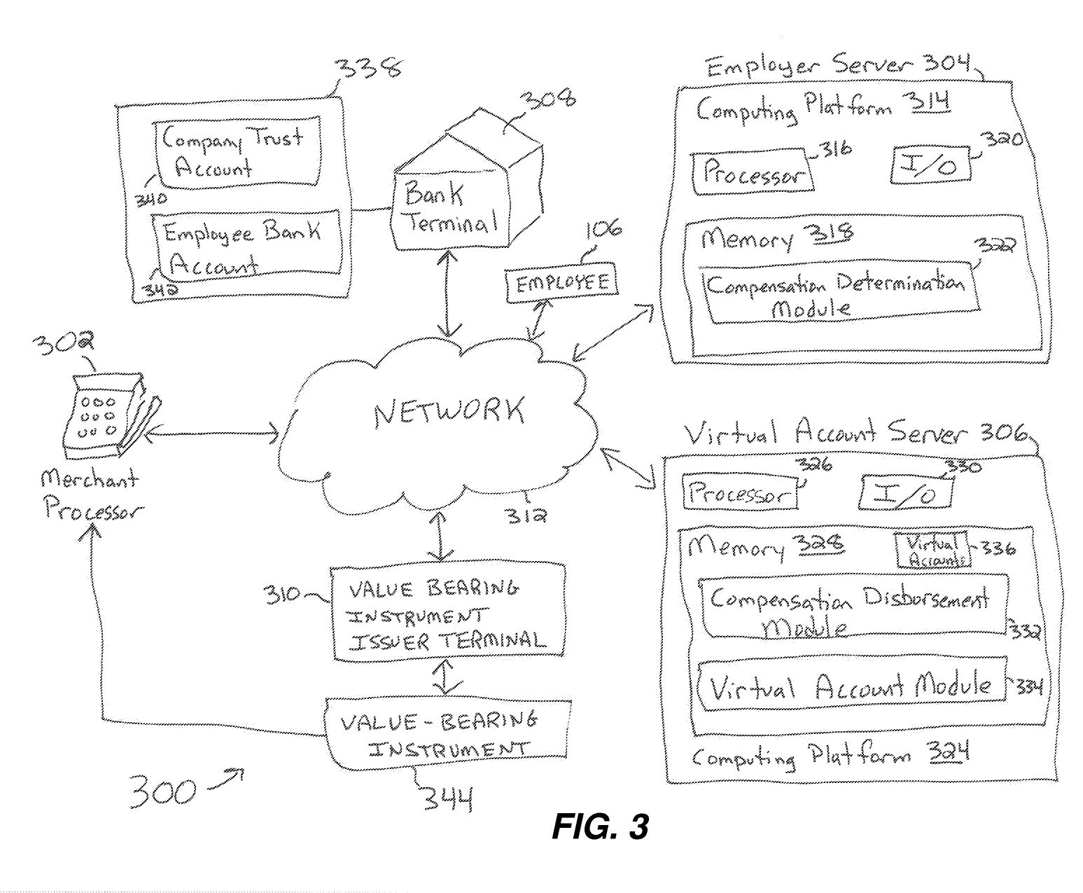

Referring now to FIG. 3, an exemplary block diagram of a system 300 for payment processing and compensation disbursement of employees is illustrated in accordance with one or more embodiments of the present disclosure. The system 300 includes a merchant processor 302, an employer server 304 or employer computing device, a virtual account server 306 or virtual account system/computing device, a bank or financial institution terminal 308, and a value-bearing instrument issuer terminal 310. The components of the system 300 may be distributed over a network 312. The network 312 may be an internet or intranet, or a combination thereof. The network 312 may further comprise a wired network or a wireless network (e.g., WiFi, CDMA, GSM, Bluetooth, etc.), or a combination thereof. For example, the components of the system 300 may be selectively distributed over the Internet as well as maintained within an intranet of an organization. Employees 106 are able to connect to components of the system 300 through computing devices that are able connect through network 312, such as through their home computers, workstations, mobile phones or PDAs or other types of electronic computing devices. Through this connection, employees 106 are able to access funds available in their virtual accounts and select the appropriate use thereof.

The merchant processor 302 may be implemented using mainframe computers, minicomputers, personal computers, and the like. The merchant processor 302 may be networked or otherwise coupled to a point-of-sale terminal or register for receiving funds in payment settlement of a purchase transaction. Information related to the purchase is relayed from the merchant processor 302 to the employer server 304. The information may be relayed in real-time, or periodically, such as once a day. In one embodiment, the information may include the transaction amount and employee identification information related to employees involved with the purchase transaction (e.g., in order to track and credit appropriate commissions based on the purchase transaction). The employee identification information may include the employee(s) name or I.D. number or other type of identifying information.

In one or more embodiments, the employer server 304 includes a computing platform 314 including at least one processor 316, memory 318 and at least one input/output device 320. In one or more embodiments, the memory 318 includes a compensation determination module 322 that is operable to determine employee compensation that is due to be paid to corresponding employees 106. The compensation determination module 322 may be used to determine the compensation of an employee for a predetermined period, for certain transactions or for other payment determinations. For example, compensation determination module 322 may utilize employee payroll information stored in memory 318 or utilize information received in connection with the merchant processor 302 (or otherwise based on purchases associated with merchant account 202) to determine the appropriate employee compensation that is due to be paid to corresponding employees 106. For example, the compensation determination module 322 may be used to determine the compensation of an employee 106 based on commissions from the purchase transaction. Hence, if an employee gets a 5% commission on any products or services sold by the employee 106, the compensation determination module 322 will determine a payment amount equivalent to $5 dollars for every $100 dollars in products or services sold. As can be appreciated, the compensation determination module 322 may be implemented by a third party provider in electronic communication with the employer server 304 via the network 312. In this manner, compensation determination module 322 alone or in combination with other components of employer server 304 may perform the functions associated with the commission engine 204 to determine appropriate employee compensation or payments. At least one input/output device 320 is provided to allow communications with the network 312 and/or to further allow inputs and control functions to be performed by a user of the employer server 304 and/or to further allow certain display functions.

In one or more embodiments, the virtual account server 306 includes a computing platform 324 including at least one processor 326, memory 328 and at least one input/output device 330. In one or more embodiments, the memory 328 includes a compensation disbursement module 332 and a virtual account module 334. The compensation determination module 322 may be operatively associated with the compensation disbursement module 332 to allocate an amount in a company's trust account 340 to the employee 106 for compensation. The compensation disbursement module 332 receives a record of the amount determined and/or computed by the compensation determination module 322 for disbursing funds to compensate the employee 106 appropriately.

In one or more embodiments, the compensation disbursement module 332 may be operatively associated with the virtual account module 334 to create and maintain virtual account record for each company employee. The virtual account record identifies the amount owed to the employee for compensation within the predetermined period. The virtual account records may be stored in the memory 328 (such as virtual accounts 336) or in devices external to virtual account server 306. As can be appreciated, virtual accounts 336 may be used to accumulate funds for each employee over multiple pay periods or transactions.

In one or more embodiments, the compensation disbursement module 332 and the virtual account module 334 may be implemented in a separate computing device from the compensation determination module 322, as shown in FIG. 3. Alternatively, the compensation disbursement module 332, the virtual account module 334, and the compensation determination module 322 may also be implemented together in the same computing device (such as entirely in employer server 304 or virtual account server 306) or all separately in separate computing devices coupled locally or remotely over the network 312.

At least one input/output device 330 is provided to allow communications with the network 312 and/or to further allow inputs and control functions to be performed by a user of the virtual account server 306 and/or to further allow certain display functions. Virtual account server 306 may also be referred to herein interchangeably as virtual account system.

In one or more embodiments, any portion of the employer server 304 or virtual account server 306 (e.g., components of memory 318, memory 328 or other components) can be provided or located externally from the employer server 304 or virtual account server 306, either locally to such servers or remotely over the network 312. The external data from an external storage device can be provided in any standardized form which the processors 316 and 328 can understand. For example, an external storage device at a provider can advantageously provide information related to the purchase transaction in response to requests from the employer server 304 in a standard format, which the processor 316 of the employer server 304 may then transform into a function call format that the code module(s) can understand. The employer server 304 and the virtual account server 306 may be a standard SQL servers, where dynamic requests from the server builds forms from one or more databases used by the employer server 304 and the virtual account server 306 as well as store and retrieve related data in memory 318 or memory 328.

As can be appreciated, memory 318 and memory 328 may be used to store, arrange and retrieve data. Memory 318 and memory 328 may be a computer readable medium, which may be any mechanism that provides (i.e. stores and/or transmits) information in a form readable by a processor. Compensation determination module 322, compensation disbursement module 332 and virtual account module 334 may comprise information and instructions stored in corresponding portions of memory 318 or memory 328 that, when executed by processor 316 or processor 326, allow the employer server 304 or the virtual account server 306 to perform the functionality described herein.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor. In one or more embodiments, the actions and/or events of a method, algorithm or module may reside as one or any combination or set of codes and/or instructions on a computer readable medium or machine readable medium, which may be incorporated into a computer program product.

In one or more embodiments, the virtual account module 334 may transmit code instructions to the bank or financial institution terminal 308 for disbursement of funds to the employee 106 up to the amount identified in the employee's virtual account 336. The bank terminal 28 may be used to access, control, and maintain bank accounts 338, including at least one company trust account 340 and/or an employee bank account 342. In one embodiment, the at least one company trust account 340 collectively maintains the total funds needed to compensate the employees based on the determinations made by compensation determination module 322. For example, if the company has ten employees, each being compensated $5000 for a particular pay period or particular transaction, the at least one company trust account 340 will have at least $50,000 in the company trust account 340. Funds may be transferred from another company account to the company trust account 340 to cover for the funds needed for employee compensation. It may be appreciated that the employee bank account(s) 342 may be located at a separate banking institution or location from the company trust account 340 and may thus utilize a separate bank terminal 308.

As described herein, in accordance with one or more embodiments, the employee 106 is provided with several options in accessing the funds maintained in his/her virtual account. The employee 106 may buy a product or service from the employer 102 or another company using the amount (or a fraction of the amount) identified in the employee virtual account. If an employee 106 buys a product or service from the employer 102, the cost for the purchase transaction may be deducted from the total amount owed in the employee's virtual account. The employee may alternatively select to transfer the funds from the virtual account to another source, as described herein, for use by the employee. Still further, the employee may select to leave funds in the virtual account until a later date. For example, commissions that are received by an employee 106 may be for small amounts that are not sufficient for purchasing additional products or services from the employer 102 or may not be worth the effort of transferring the funds to another source, such that the employee 106 can leave the funds in their virtual account until they accrue to a sufficient value so that they can be used for other purposes.

In one or more embodiments, the employee 106 may also receive a value-bearing device or instrument 344, such as a payroll card, a debit card (e.g., a branded Mastercard® or Visa® debit card), a fob, a handheld computing device capable of storing an account with value (e.g., a mobile phone, PDA, etc.) and the like. A value-bearing instrument issuer terminal 310 may receive code instructions, such as from the virtual account server 306 or employer server 304, to issue a value-bearing instrument 344 with a certain value, for example, equal to the amount identified in the employee's virtual account record. The employee 106 may present his/her value-bearing instrument 344 to any merchant to utilize the funds transferred thereto. For example, when the value-bearing instrument 344 is a debit card, the debit card may be swiped at a merchant terminal, such the merchant's existing debit card terminal 302. As can be appreciated by a person skilled in the art, the merchant may not need any special equipment, software or processor cooperation. The merchant terminal may transmit an identifier associated with the debit card and/or the employee virtual account, back to the virtual account server 306 or employer server 304 via the network 312, to deduct a purchase transaction amount from the total balance identified in the employee's virtual account. As can be appreciated, the funds used to pay for the purchase transaction may be withdrawn from the company trust account 340, but may not exceed the amount allocated to the employee in his/her virtual account record.

In one or more embodiments, employees receive an actual or virtual card as the value-bearing instrument 344, such that the employer 102 may directly deposit the employee's compensation to the card. The money does not need to leave the company trust account 340 until actually used by the employee 106 for a purchase, and as such, the employer 102 maintains a float on the funds made available to the employee 106. Furthermore, the employees 106 need not pay for monthly fees to maintain the debit cards and the company may also retain any unused or unrealized funds (e.g., those typically retained when breakage occurs with checks).

In one or more embodiments, the systems, methods and computer program products of the present disclosure may be utilized by international companies with employees 106 in more than one country, without having to deal with currency conversion. Currently, many companies have a challenge with settling funds in the currency of the country where they are doing business. This can be very costly in terms of currency conversion rates. However, using the systems, methods and computer program products of the present disclosure, companies can process virtual accounts and/or debit cards in most countries and settle in the local currency without requiring one or more currency exchanges to take place, thereby representing a huge potential savings to the companies.

For example, an employee of Dell® in Europe receiving a commission on the sale of a Dell® computer to a resident of France, where payment was made in Euros, may have a virtual account record of the employee's compensation in Euros, and may withdraw the funds from the company trust account 340 (associated with funds authorized in their virtual account) in the equivalent of Euros. In one embodiment, the company may have separate company trust accounts 340 for each country or region the company is doing business in and/or in the foreign currency of that country or region. Hence, when utilizing region-specific trust accounts, the company trust account 340 for Europe may be set up in Europe for maintaining and distributing funds in the Euro currency while a separate company trust account 340 for the United States may be set up in the United States for maintaining and distributing funds in U.S. currency. As such, the company and the employee avoid the costs associated with currency conversion rates, while still taking advantage of all of the benefits associated with payment through virtual accounts as described herein.

In this description, various functions and operations may be described as being performed by or caused by software code to simplify description (e.g., certain modules stored in memory 318 and 328). However, those skilled in the art will recognize that what is meant by such expressions is that the functions result from execution of the code/instructions by a processor, such as a processor 316 or 326. Alternatively, or in combination, the functions and operations can be implemented using hard wired circuitry or special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system. While some embodiments can be implemented in fully functioning computers and computer systems, various embodiments are capable of being distributed as a computing product in a variety of forms and are capable of being applied regardless of the particular type of machine or computer-readable media used to actually effect the distribution.

Routines executed to implement the embodiments may be implemented as part of an operating system or a specific application, component, program, object, module or sequence of instructions referred to as “computer programs” or modules. The computer programs typically include one or more instructions set at various times in various memory and storage devices in a computer, and that, when read and executed by one or more processors in a computer, cause the computer to perform operations necessary to execute elements involving the various aspects.

The executable software and data may be stored in various places including for example memory, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a computer readable medium in entirety at a particular instance of time. In general, a tangible computer readable storage medium includes any mechanism that provides (i.e., stores and/or allows to be retrieved) information in a form accessible by a machine (e.g., a computer, network device, personal digital assistant, manufacturing tool, any device with a set of one or more processors, etc.).

In various embodiments, although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof. The disclosure includes methods and apparatuses which perform these methods, including data processing systems which perform these methods, and computer readable media containing instructions which when executed on data processing systems cause the systems to perform these methods.

While the methods and systems have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes. Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates. Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive forms so as to afford the applicant the broadest coverage legally permissible in accordance with the following claims.

1. A method of processing employee compensation payments comprising:
receiving information relating to compensation disbursements to be paid to one or more employees;
providing an indication of available funds corresponding to a compensation disbursement to be paid to an employee into at least one virtual account associated with said employee, wherein each virtual account includes only an indication of available funds but does not include actual funds transferred from a payment source; and
providing said employee with a plurality of possible alternatives for accessing and utilizing the funds indicated as available in said employee's virtual account.

2. The method of claim 1, further comprising providing said employee with an opportunity to make purchases back from the employee's employer using funds available in employee's virtual account.

3. The method of claim 2, further comprising providing said employee with incentives for making purchases back from the employee's employer using funds available in employee's virtual account.

4. The method of claim 1, further comprising providing said employee with the ability to select one of the following possible alternatives for accessing and utilizing the funds indicated as available in said employee's virtual account:
maintaining the available funds within the virtual account;
transferring funds from the employee's virtual account to a bank account; or
transferring funds from the employee's virtual account to a value bearing device or instrument.

5. The method of claim 1, further comprising providing said employee with an opportunity to transfer funds from the employee's virtual account to another virtual account.

6. The method of claim 1, further comprising determining the compensation disbursements of the employees to be paid.

7. The method of claim 6, wherein the amount of a compensation disbursement for an employee is determined based on a purchase transaction facilitated by the employee.

8. A payment processing apparatus comprising:
a computing platform including at least one processor and a memory, wherein the memory stores and maintains data comprising at least one employee virtual account; and
computer code stored in the memory and executable by the at least one processor and operable for:
receiving information relating to compensation disbursements to be paid to one or more employees;
providing an indication of available funds corresponding to a compensation disbursement to be paid to an employee into at least one virtual account associated with said employee, wherein each virtual account includes only an indication of available funds but does not include actual funds transferred from a payment source; and
providing said employee with a plurality of possible alternatives for accessing and utilizing the funds indicated as available in said employee's virtual account.

9. The payment processing apparatus of claim 8, wherein the computer code is further executable by the processor and operable for providing said employee with an opportunity to make purchases back from the employee's employer using funds available in employee's virtual account.

10. The payment processing apparatus of claim 9, wherein the computer code is further executable by the processor and operable for providing said employee with incentives for making purchases back from the employee's employer using funds available in employee's virtual account.

11. The payment processing apparatus of claim 8, wherein the computer code is further executable by the processor and operable for providing said employee with the ability to select one of the following possible alternatives for accessing and utilizing the funds indicated as available in said employee's virtual account:
maintaining the available funds within the virtual account;
transferring funds from the employee's virtual account to a bank account; or
transferring funds from the employee's virtual account to a value bearing device or instrument.

12. The payment processing apparatus of claim 8, wherein the computer code is further executable by the processor and operable for providing said employee with an opportunity to transfer funds from the employee's virtual account to another virtual account.

13. The payment processing apparatus of claim 8, wherein the computer code is further executable by the processor and operable for determining the compensation disbursements of the employees to be paid.

14. The payment processing apparatus of claim 13, wherein the amount of a compensation disbursement for an employee is determined based on a purchase transaction facilitated by the employee.

15. A computer program product, comprising:
a tangible computer readable storage medium including computer-executable instructions executed by a computer system, said computer-executable instructions comprising:
a compensation disbursement module including a first set of instructions, executable on said computer system, for causing a computer to receive information relating to compensation disbursements to be paid to one or more employees;
a virtual account module including a second set of instructions, executable on said computer system, for providing an indication of available funds corresponding to a compensation disbursement to be paid to an employee into at least one virtual account associated with said employee, wherein each virtual account includes only an indication of available funds but does not include actual funds transferred from a payment source; and
the virtual account module including a third set of instructions, executable on said computer system, for providing said employee with a plurality of possible alternatives for accessing and utilizing the funds indicated as available in said employee's virtual account.

16. The computer program product of claim 15, said computer-executable instructions further comprising a fourth set of instructions, executable on said computer system, for providing said employee with an opportunity to make purchases back from the employee's employer using funds available in employee's virtual account, where said employee is provided incentives for making purchases back from the employee's employer using funds available in employee's virtual account.

17. The computer program product of claim 15, said computer-executable instructions further comprising a fifth set of instructions, executable on said computer system, for providing said employee with the ability to select one of the following possible alternatives for accessing and utilizing the funds indicated as available in said employee's virtual account:
maintaining the available funds within the virtual account;
transferring funds from the employee's virtual account to a bank account; or
transferring funds from the employee's virtual account to a value bearing device or instrument.

18. The computer program product of claim 17, wherein said fifth set of instructions are further executable by said computer system for transmitting instructions to a financial institution terminal to debit from a company trust account an amount less than or equal to an amount stored in the employee virtual account.

19. The computer program product of claim 17, wherein said fifth set of instructions are further executable by said computer system for transmitting instructions to a value-bearing instrument issuer terminal to issue said value bearing device or instrument to the employee, said value bearing device or instrument having an identifier associated with the employee virtual account and accessing funds in a company trust account in an amount equal to or less than an amount stored in the employee virtual account.

20. The computer program product of claim 15, said computer-executable instructions further comprising a sixth set of instructions, executable on said computer system, for determining the compensation disbursements of the employees to be paid.

21. A payment processing system comprising:
a merchant account computer system for processing electronic purchases of merchant products and/or services and for associating said electronic purchases with at least one employee;
an employee compensation determination system comprising:
a first computing platform including at least one processor and a memory, and
computer code stored in the memory of the first computing platform and executable by its at least one processor and operable for determining compensation to be disbursed to said at least one employee in connection with said electronic purchases; and
a virtual account payment system comprising:
a second computing platform including at least one processor and a memory, and
computer code stored in the memory of the second computing platform and executable by its at least one processor and operable for
providing an indication of available funds corresponding to a compensation disbursement determined to be paid to an employee into at least one virtual account associated with said employee, wherein each virtual account includes only an indication of available funds but does not include actual funds transferred from a payment source; and
providing said employee with a plurality of possible alternatives for accessing and utilizing the funds indicated as available in said employee's virtual account,
wherein said alternatives for accessing and utilizing virtual account funds include (i) transferring funds from the employee's virtual account to a bank account and (ii) transferring funds from the employee's virtual account to a value bearing device or instrument.

22. The payment processing system of claim 21, wherein each employee is capable of transferring funds from their own employee virtual account in their own respective local currency of their geographic region without requiring currency conversion.
